(19) United States
(12) Patent Application Publication
(10) Pub. No.: US 2012/0234488 A1
(43) Pub. Date: Sep. 20, 2012

(54) MAGNETIC HOT MELT ADHESIVE AND METHODS OF MAKING AND USING THE SAME

(75) Inventors: John C. Ulicny, Oxford, MI (US); Paul E. Krajewski, Troy, MI (US); Mark A. Golden, Washington, MI (US); Keith S. Snavely, Sterling Heights, MI (US)

(73) Assignee: GM GLOBAL TECHNOLOGY OPERATIONS LLC, DETROIT, MI (US)

(21) Appl. No.: 13/051,323

(22) Filed: Mar. 18, 2011

(51) Int. Cl. B32B 37/06; H01F 1/20

(52) U.S. Cl. 156/272.4; 252/62.54

(57) ABSTRACT

One embodiment includes a magnetic particle-containing adhesive an adhesive including a polymer resin having a softening temperature; and magnetic particles dispersed within the polymer resin.

### TECHNICAL FIELD

The field to which the disclosure generally relates to includes hot melt adhesives and methods of making and using the same.

### BACKGROUND

Induction heating may generally be accomplished by generating magnetic flux through an inductor coil which is part of a tank circuit or LCR circuit and transferring the magnetic flux to a susceptor which is heated. For example, the tank circuit is connected to a power supply which provides an alternating current of predetermined frequency. The heating gun is positioned proximate to the heating area. The alternating current in the inductor coil creates a magnetic flux within the turns of the coil which is then transferred to the susceptor which creates eddy currents in the susceptor which results in heat being generated in the susceptor.

### SUMMARY OF EXEMPLARY EMBODIMENTS OF THE INVENTION

One exemplary embodiment includes a magnetic particle-containing adhesive is provided including an adhesive comprising a polymer resin having a softening temperature; and magnetic particles dispersed within the polymer resin.

Another exemplary embodiment includes a method of forming a magnetic particle-containing adhesive is provided including providing an adhesive including a polymer resin having a softening temperature; providing magnetic particles; mixing the magnetic particles and the adhesive material to form a dispersion of the magnetic particles in the adhesive; and, cooling the adhesive to form a composite material including the magnetic particle containing adhesive.

Another exemplary embodiment includes a method of bonding surfaces is provided including providing a first bonding surface; providing a magnetic particle-containing adhesive in powdered form dispersed on the bonding surface, the magnetic particle-containing adhesive including: an adhesive including a polymer resin having a softening temperature; and magnetic particles dispersed within the polymer resin; providing one or more magnets proximate the bonding surface to accumulate said hot melt adhesive in predetermined locations on the bonding surface; heating the hot melt adhesive to a softening temperature; contacting a second bonding surface with the softened hot melt adhesive; and, cooling the softened hot melt adhesive while in contact with the second bonding surface to form a bond bridging the first and second bonding surfaces.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIGS. 1A-1F show magnetic particles and magnetic particle hot melt adhesive power according to exemplary embodiments.

FIG. 2A shows an exemplary arrangement of magnetic hot melt adhesive particles and associated magnets according to an exemplary embodiment.

FIG. 2B shows an exemplary arrangement of magnetic hot melt adhesive particles and associated magnets with the according to an exemplary embodiment.

FIG. 3A shows an exemplary arrangement of two parts being bonded together by the magnetic particle-containing hot melt adhesive according to an exemplary embodiment.

FIG. 3B shows an exemplary arrangement of an adhesive including magnetic particles being heated by induction heating to bond two parts together according to an exemplary embodiment.

FIG. 4 shows an exemplary process flow to bond two surfaces together using the magnetic particle-containing hot melt adhesive according to an exemplary embodiment.

### DETAILED DESCRIPTION OF EXEMPLARY EMBODIMENTS

The following description of the embodiment(s) is merely exemplary (illustrative) in nature and is in no way intended to limit the invention, its application, or uses.

In an exemplary embodiment, magnetic particles are provided in a hot melt adhesive. The term “hot melt adhesive” means a polymer organic material, such a resin, plastic, thermoplastic, or thermoset that exhibits the properties of a solid (e.g., substantially non-flowable) at lower temperatures, preferably including room temperature, and which exhibits a softening temperature, also referred to as a melting temperature at higher temperatures including higher than room temperature where the organic material is flowable, e.g., exhibits a measurable viscosity e.g., measurable by conventional means.

In an exemplary embodiment, the polymer resin has a softening (melting) temperature greater than about 85° C., more preferably from about 90° C. to about 350° C., more preferably from about 90° C. to about 300° C.

In an exemplary embodiment, magnetic particles are provided dispersed in the hot melt adhesive. The magnetic particles may be provided in a range of particle sizes, which may vary over a primary particle size range including, but not limited to, about 20 nm to about 100 microns; from about 100 nm to about 50 microns; from about 200 nm to about 10 microns. For example, the effective primary particle size may be expressed as volume average particle size or weight average particle size and may be determined by known approaches including visually by a transmission electron microscope (TEM), measurement of surface area by gas e.g., N₂ adsorption, or x-ray spectroscopy. For example, the magnetic particles may have measured surface areas of about 3 m²/g to about 50 m²/g.

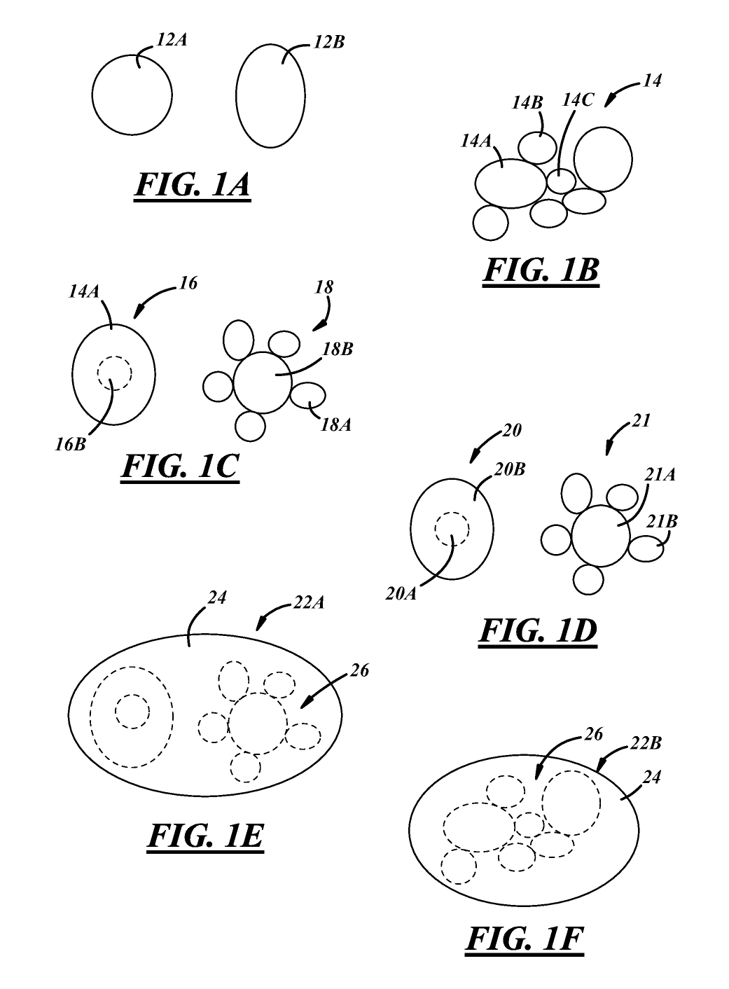

In another exemplary embodiment, the magnetic particles may further be provided in the hot melt adhesive as particles having a size within a narrow range, e.g., where the size variation among particles is less than about 20 percent, more preferably less than about 10 percent. It will be appreciated that the magnetic particles may be in any shape, including substantially spherical 12A or oval shaped 12B e.g., as shown in FIG. 1A, as well as polyhedral and/or flake-shaped, and may include agglomerates e.g., 14 in FIG. 1B made up of a plurality of agglomerated smaller particles, e.g., 14A, 14B, 14C, where the smaller particles are either partially bonded or held together by physical forces e.g., as shown in FIG. 1B.

The magnetic particles may be formed by any process known in the art including, but not limited to, physical processes such as grinding or pulverizing larger magnetic pieces into smaller particles, as well as chemical processes such as sol-gel or flame pyrolysis. The magnetic particles may include iron and/or magnetic iron oxide.

Referring to FIG. 1C, in another exemplary embodiment, the particles e.g., 16 may be provided as a cladding e.g., 16A of magnetic material surrounding one or more second materials e.g., 16B, which may be an electrically conductive metal or oxide, an electrically insulating oxide, or an organic material including the same or similar material as the hot melt adhesive. In another exemplary embodiment, the magnetic particles e.g., 18 may be individual smaller particles e.g., 18A surrounding one or more second materials e.g., 18B. It will be appreciated that the particles 16 and 18 may be further agglomerated, including to each other, to form larger particle agglomerates.

Referring to FIG. 1D, in another exemplary embodiment, the particles, e.g., 20 may be provided as a core e.g., 20A of magnetic material surrounded by one or more non-magnetic materials e.g., 20B, where the one or more surrounding non-magnetic materials are least partially and preferably substantially transparent to magnetic flux, such that the core may be heated by inductive heating. The surrounding non-magnetic materials may be an oxide, or an organic material including the same or similar material as the hot melt adhesive. In another exemplary embodiment, the magnetic particles e.g., 21 may include individual particles e.g., 21A surrounded by one or more second materials e.g., 21B. It will be appreciated that the particles 20 and 21 may be further agglomerated, including to each other, to form larger particle agglomerates.

In another exemplary embodiment, the magnetic particles are dispersed in the hot melt adhesive, by known manufacturing techniques, including e.g., melting the hot melt adhesive and stirring in the magnetic particles at a predetermined weight or volume percent, preferably substantially uniformly dispersing the magnetic particles within the hot melt. The hot melt may then be cooled e.g., to about room temperature and a powder formed from the resulting hardened composite hot melt adhesive material (magnetic particle-containing hot melt adhesive), for example by crushing the hardened adhesive including the magnetic particles.

Referring to FIGS. 1E and 1F, in another exemplary embodiment, the hot melt adhesive powder particles 22A, 22B including hot melt adhesive material 24, and smaller magnetic containing particles e.g., 26 may have any shape including substantially spherical or oval and may surround one or more smaller magnetic containing particles e.g., 26 that may have one or more of the shapes/configurations shown in FIGS. 1A-1D. It will further be appreciated that the hot melt adhesive powder particles 22A, 22B may further be agglomerated into larger particle agglomerates, and may have a range of particle sizes. For example, the hot melt adhesive powder particles may have a primary particle size from of about 1 micron to about 1000 microns, more preferably from about 1 micron to about 500 microns.

In another an exemplary embodiment, the magnetic particles may be present at a weight percent in the hot melt adhesive, prior to and/or following formation of a powder, in the range of about 1 wt % to about 80 wt %, more preferably from about 5 wt % to about 50 wt %, even more preferably from about 10 wt % to about 30 wt %.

In another exemplary embodiment, the magnetic hot melt adhesive prior to and/or following formation of a powder may include from about 1 vol % to about 50 vol % of magnetic particles, more preferably, from about 5 vol % to about 30 vol %, even more preferably from about 10 vol % to about 20 vol %.

Although the resulting powder (hot melt particles) may include hot melt adhesive particles fully surrounding a magnetic particle, e.g., as shown in FIGS. 1E and 1F, it will be appreciated that the hot melt adhesive material e.g., 24 may not fully surround a smaller magnetic containing particle e.g., 26, following formation of powdered magnetic particle containing hot melt material.

It will further be appreciated that the magnetic hot melt adhesive particles 22a, 22B may be individual particles with any shape and/or agglomerated particles which may further include one or more smaller magnetic containing particles e.g., 26 of any shape and/or agglomerates of particles.

It has been found that the smaller magnetic containing particles e.g., 26 may also lend increased strength and durability to the adhesive material 24, as compared to the neat adhesive material alone. For example, in one embodiment, the composite magnetic particle containing adhesive material has an increased shear stress compared to the neat adhesive material alone. Bonding between the particles e.g., 26 and the adhesive material 24 may be increased, further increasing the strength and durability of the composite, by the use of surface treatments and coupling agents. For example, surface treatment agents such as various forms of waxes (e.g, polyethylene glycols) and silane coupling agents with a general formula such as R—(CH2)n—Si—X3 _ where R is an organofunctional group, (CH2)n is an organic linker group, Si is a silicon atom and X is a hydrolyzable group typically an alkoxy, acyloxy, halogen or amine, may be used to treat the magnetic particle surfaces prior to mixing with the hot melt adhesive or added to a mixture of the hot melt adhesive and the magnetic particles.

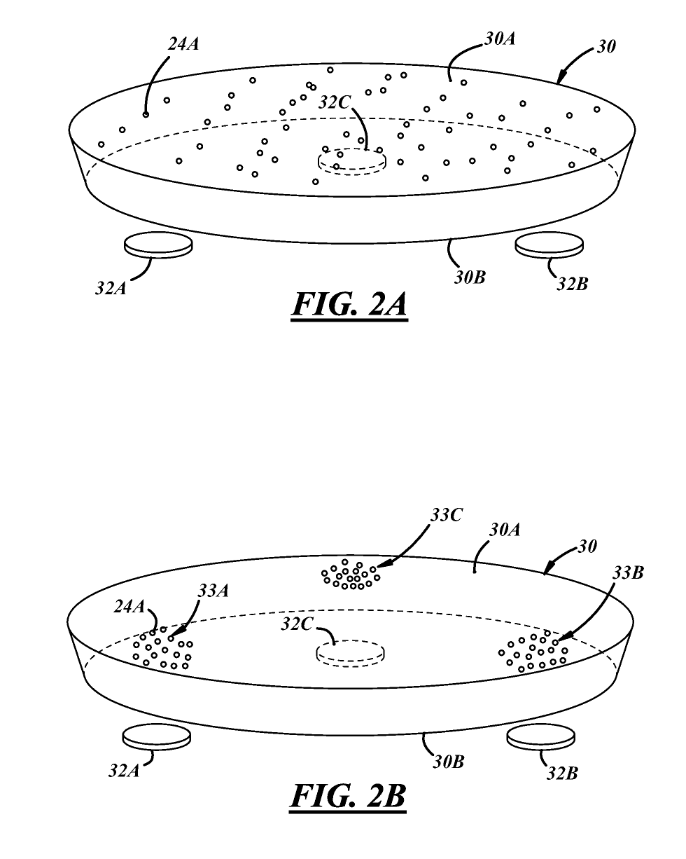

Referring to FIG. 2A, in another exemplary embodiment, in a method of using the magnetic particle containing hot melt adhesive, particles of the magnetic particle containing hot melt adhesive (hot melt adhesive particles) e.g., 24A, are provided dispersed on a bonding surface e.g., 30A of a part e.g., 30 to be bonded.

Magnets (exuding magnetic flux) may then be provided proximate the bonding surface 30A (e.g., above or below) or on the bonding surface 30A in order to arrange the magnetic hot melt adhesive particles e.g., 24A, to a predetermined location proximate the magnets where the magnetic flux is greatest prior to heating the hot melt adhesive particles to a softening or melting temperature in a bonding process.

In an exemplary embodiment, still referring to FIG. 2A, magnets 32A and 32B may be provided proximate a surface 30B, e.g., on the opposite side of the bonding surface 30A on which the hot melt adhesive particles e.g., 24A are dispersed. It will be appreciated that the magnets may be permanent magnets or transitory magnets (e.g., electromagnets) capable of having a magnetic flux turned on or off. In the case that the magnets are permanent magnets, the magnetic hot melt particles may substantially simultaneously arrange (accumulate) proximate an area of greatest magnetic flux (e.g., (e.g., 33A, 33B, above the magnets) as shown in FIG. 2B upon positioning of the magnets 32A and 32B proximate surface 30B. In the case the magnets are electromagnets, the magnetic hot melt particles may substantially simultaneously arrange above the magnets as shown in FIG. 2B upon supplying power to the magnets 32A and 32B (turning the magnets on).

In another exemplary embodiment, permanent and/or temporary magnets may be included on (e.g., 32C in FIG. 2A and 2B) or embedded under a bonding surface e.g., 30A prior to or following dispersing of magnetic hot melt particles on the bonding surface 30A to arrange accumulate the magnetic hot melt particles to a desired location e.g., 33C.

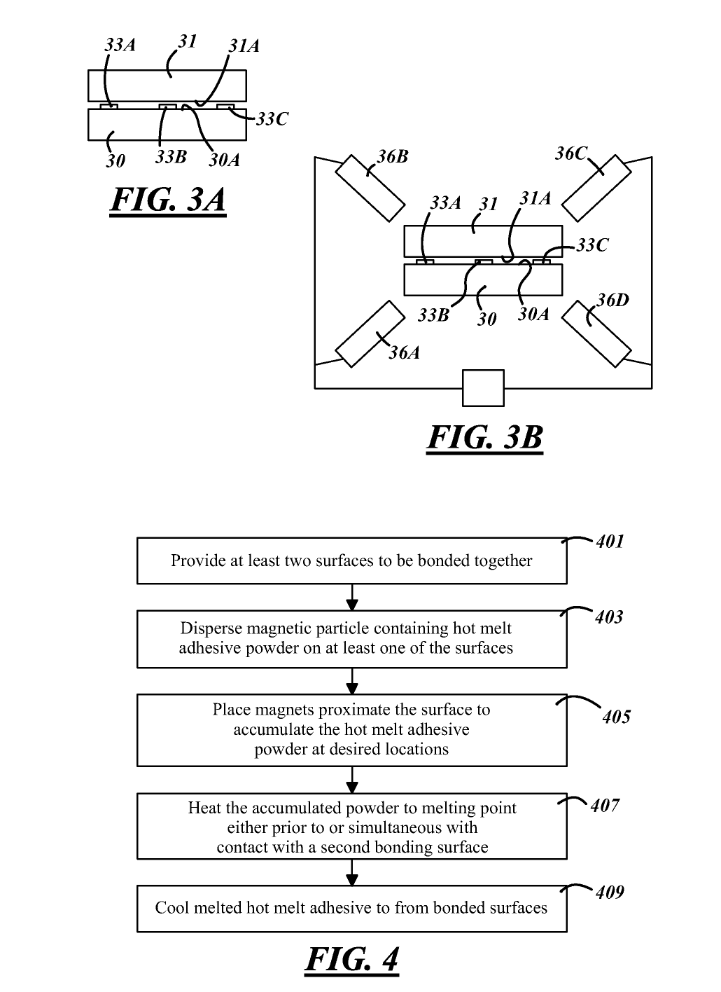

Referring to FIG. 3A, following rearrangement of the magnetic hot melt particles to desired selected positions e.g., 33A, 33B, 33C, the magnets e.g., 32A, 32B, 32C may be turned off and/or removed and the arranged (accumulated) magnetic hot melt particles heated to and/or above a softening or melting temperature either prior to contacting a second bonding surface, e.g., 31A of another part e.g., 31 (which may or may not also include pre-arranged magnetic hot melt particles) to the bonding surface 30A or during contacting of the second bonding surface 31A with the first bonding surface 30A. The heating may be provided by any energy source including one or more of a conventional furnace, hot plate, RF source, laser source, and induction heating source. The hot melt adhesive containing magnetic particles are preferably heated to a softening or melting temperature to produce adhesive bonds only at the desired locations e.g., where the hot melt particles have been magnetically arranged (accumulated).

In another exemplary embodiment, the heating source may be an induction heating source. Any induction heating source may be used for inductively heating the magnetic particle containing hot melt adhesive. For example, suitable inductive heating devices are described in U.S. Pat. Nos. 4,521,659, 5,266,764, 5,374,808, and 5,919,387.

Referring to FIG. 3B, in an exemplary embodiment, one or more conventional induction heating heads e.g., 36A, 36B, 36C, 36D may be arranged proximate the bonding parts e.g., 30 and 31 and respectively associated bonding surfaces e.g., 30A and 31A and AC power supplied e.g., by power source 40 to the one or more heating heads e.g., e.g., 36A, 36B, 36C, 36D to produce magnetic flux to heat the magnetic particles at least partially contained in the hot melt adhesive material. While any conventional induction heating source/head may be used, in an exemplary embodiment, the induction heating heads e.g., 36A, 36B, 36C, include one or more LCR circuits that preferably may be adjusted to operate at different frequencies. It will be appreciated that the bonding parts 30 and 31 may be at least partially transparent to magnetic flux lines.

Referring to FIG. 4 is a process flow diagram including several embodiments. In step 401, at least two surfaces to be bonded together are provided. In step 403 at least one of the surfaces is provided with magnetic particle containing hot melt adhesive powder. In step 405, the magnetic particle containing hot melt adhesive powder may be accumulated at selected desired location on the surface by magnets provided proximate the selected locations. In step 407, the magnetic particle containing hot melt adhesive powder is heated to a softening (melting) temperature either prior to or simultaneous with contact with a second boding surface. In step 409, the softened magnetic particle containing hot melt adhesive is cooled while in contact with the second bonding surface to form surfaces bonded together through the hot melt adhesive.

The above description of embodiments of the invention is merely exemplary in nature and, thus, variations thereof are not to be regarded as a departure from the spirit and scope of the invention.

What is claimed is:

1. A product comprising:
an adhesive comprising a polymer resin having a softening temperature; and
magnetic particles dispersed within the polymer resin.

2. A product as set forth in claim 1, wherein said adhesive comprises one or more of a plastic, a hot melt, a thermoplastic, and a thermoset.

3. A product as set forth in claim 1, wherein the softening temperature is from about 90° C. to about 300° C.

4. A product as set forth in claim 1, wherein said magnetic particles have a size range of from about 20 nm to about 100 microns.

5. A product as set forth in claim 1, wherein said magnetic particles comprise an outer layer of magnetic material.

6. A product as set forth in claim 1, wherein said magnetic particles comprise an inner core of magnetic material.

7. A product as set forth in claim 1, wherein said magnetic particles are present at a vol % of about 1 vol % to about 80 vol %.

8. A product as set forth in claim 1, wherein said magnetic particles are present at a wt % of about 1 wt % to about 50 wt %

9. A product as set forth in claim 1, wherein said magnetic particles comprise iron.

10. A product as set forth in claim 1, wherein said hot melt adhesive is a powder.

11. A method comprising:
providing an adhesive comprising a polymer resin having a softening temperature;
providing magnetic particles;
mixing said magnetic particles and said adhesive material to form a dispersion of said magnetic particles in said adhesive; and,
cooling said adhesive to form a composite material comprising said magnetic particle containing adhesive.

12. A method as set forth in claim 11, further comprising forming a powder from said magnetic particle containing adhesive.

13. A method as set forth in claim 11, wherein said polymer resin comprises one or more of a plastic, a hot melt, a thermoplastic, and a thermoset.

14. A method as set forth in claim 11, wherein the softening temperature is from about 90° C. to about 300° C.

15. A method as set forth in claim 11, wherein each of said magnetic particles has a size range of from about 20 nm to about 100 microns.

16. A method as set forth in claim 11, wherein said magnetic particles comprise an outer layer of magnetic material.

17. A method as set forth in claim 11, wherein said magnetic particles comprise an inner core of magnetic material.

18. A method as set forth in claim 11, wherein said magnetic particles are present at a vol % of about 1 vol % to about 80 vol %.

19. A method as set forth in claim 11, wherein said magnetic particles are present at a wt % of about 1 wt % to about 50 wt %.

20. A method as set forth in claim 11, wherein said magnetic particles comprise iron.

21. A method of bonding surfaces comprising:
providing a first bonding surface;
providing a magnetic particle containing adhesive in powdered form dispersed on said bonding surface, said magnetic particle containing adhesive comprising:
an adhesive comprising a polymer resin having a softening temperature; and
magnetic particles dispersed within the polymer resin;
providing one or more magnets proximate said bonding surface to accumulate said hot melt adhesive in predetermined locations on said bonding surface;
heating said hot melt adhesive to a softening temperature;
contacting a second bonding surface with the softened hot melt adhesive; and,
cooling said softened hot melt adhesive while in contact with said second bonding surface to form a bond bridging said first and second bonding surfaces.

22. A method as set forth in claim 21 wherein said heating comprises a heat source comprising at least one of a furnace source, hot plate, RF source, laser source, and induction heating source.

23. A method as set forth in claim 21 wherein said heating comprises an induction heating source.

24. A method as set forth in claim 21 wherein said one or more magnets are at least one of permanent magnets and electromagnets.

25. A method as set forth in claim 21, wherein said polymer resin comprises at least one of a plastic, a hot melt, a thermoplastic, or a thermoset.

26. A method as set forth in claim 21, wherein the softening temperature is from about 90° C. to about 300° C.

27. A method as set forth in claim 21, wherein said magnetic particles have a size range of from about 20 nm to about 100 microns.

28. A method as set forth in claim 21, wherein said magnetic particles are present at a vol % of about 1 vol % to about 80 vol %.

29. A method as set forth in claim 21, wherein said magnetic particles are present at a wt % of about 1 wt % to about 50 wt %.
